(19) United States
(12) Patent Application Publication
(10) Pub. No.: US 2015/0380755 A1
(43) Pub. Date: Dec. 31, 2015

(54) FUEL CELL SYSTEM AND FUEL CELL VEHICLE

(71) Applicant: HONDA MOTOR CO., LTD., Tokyo (JP)

(72) Inventor: Shuichi KAZUNO, Wako (JP)

(73) Assignee: HONDA MOTOR CO., LTD., Tokyo (JP)

(21) Appl. No.: 14/723,460

(22) Filed: May 28, 2015

(30) Foreign Application Priority Data
Jun. 30, 2014 (JP) 2014-133807

(51) Int. Cl. H01M 8/04; B60L 11/18

(52) U.S. Cl. CPC H01M 8/04873; H01M 8/04492; H01M 8/04291; H01M 8/04828; B60L 11/1883

(57) ABSTRACT

A fuel cell system includes a fuel cell, a voltage adjustment device, a controller, and a moisture content detector. The voltage adjustment device is configured to adjust output voltage from the fuel cell and configured to apply the output voltage to a load. The controller is configured to supply an instruction signal including an alternating current signal and a target value of the output voltage to the voltage adjustment device to control the voltage adjustment device. The moisture content detector is configured to detect an alternating current signal component included in the output voltage to detect actual moisture content in the fuel cell based on the alternating current signal component. The controller is configured to increase the actual moisture content before setting the voltage adjustment device to a direct connection state.

### CROSS-REFERENCE TO RELATED APPLICATIONS

The present application claims priority under 35 U.S.C. §119 to Japanese Patent Application No. 2014-133807, filed Jun. 30, 2014, entitled “Fuel cell system and fuel cell vehicle.” The contents of this application are incorporated herein by reference in their entirety.

### BACKGROUND

1. Field

The present disclosure relates to a fuel cell system and a fuel cell vehicle.

2. Description of the Related Art

Domestic Re-publication of PCT International Publication for Patent Application No. 2010/143250 discloses a technology in which a voltage adjustment unit adjusts output voltage on the basis of an instruction signal resulting from superimposition of an alternating current signal on a target value of the output voltage from a fuel cell and the impedance in the fuel cell is estimated on the basis of the alternating current signal component included in the output voltage.

With this technology, a control apparatus in the fuel cell system generates the instruction signal resulting from superimposition of the alternating current signal on the target value and supplies the instruction signal to the voltage adjustment unit. The voltage adjustment unit performs a switching operation (step up-down operation) on the basis of the instruction signal to adjust the output voltage to the target value and generates alternating current voltage to apply the generated alternating current voltage to the fuel cell.

The output voltage from the fuel cell is detected by a voltage sensor and the output current from the fuel cell is detected by a current sensor. The control apparatus calculates the impedance in the fuel cell using the alternating current signal components (the alternating current voltage and the alternating current) of the output voltage and the output current that are detected. As a result, the control apparatus is capable of estimating the actual moisture content in the fuel cell on the basis of the calculated impedance and appropriately controlling, for example, the amount of supply of reaction gas to be supplied to the fuel cell on the basis of the estimated actual moisture content.

### SUMMARY

According to one aspect of the present invention, a fuel cell system includes a fuel cell, a load, a voltage adjustment unit, a control unit, and a moisture content detecting unit. The voltage adjustment unit adjusts output voltage from the fuel cell and applies the output voltage to the load. The control unit controls the voltage adjustment unit. The moisture content detecting unit detects actual moisture content in the fuel cell. The control unit controls the voltage adjustment unit by supplying an instruction signal resulting from superimposition of an alternating current signal on a target value of the output voltage to the voltage adjustment unit. The moisture content detecting unit detects an alternating current signal component included in the output voltage to detect the actual moisture content on the basis of the detected alternating current signal component. The control unit increases the actual moisture content before setting the voltage adjustment unit to a direct connection state.

According to another aspect of the present invention, a fuel cell vehicle includes a driving motor. The driving motor of the fuel cell vehicle is included in the load in the fuel cell system.

According to further aspect of the present invention, a fuel cell system includes a fuel cell, a voltage adjustment device, a controller, and a moisture content detector. The voltage adjustment device is configured to adjust output voltage from the fuel cell and configured to apply the output voltage to a load. The controller is configured to supply an instruction signal including an alternating current signal and a target value of the output voltage to the voltage adjustment device to control the voltage adjustment device. The moisture content detector is configured to detect an alternating current signal component included in the output voltage to detect actual moisture content in the fuel cell based on the alternating current signal component. The controller is configured to increase the actual moisture content before setting the voltage adjustment device to a direct connection state.

According to the other aspect of the present invention, a fuel cell vehicle includes a driving motor. The driving motor of the fuel cell vehicle is included in the load in the fuel cell system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 schematically illustrates an example of the entire configuration of a fuel cell vehicle to which a fuel cell system according to an embodiment is applied.

FIG. 2 is a block diagram of an electrical power system of the fuel cell vehicle in FIG. 1.

FIG. 3 schematically illustrates an exemplary configuration of a fuel cell unit in FIG. 1.

FIG. 4 is a graph illustrating an IV characteristic of a fuel cell in FIG. 1.

FIG. 5 is a flowchart illustrating an exemplary control operation process by an ECU in the present embodiment.

FIG. 6 is an exemplary timing chart when an FCVCU is switched from a step up-down state to a direct connection state in the present embodiment.

### DESCRIPTION OF THE EMBODIMENTS

The embodiments will now be described with reference to the accompanying drawings, wherein like reference numerals designate corresponding or identical elements throughout the various drawings.

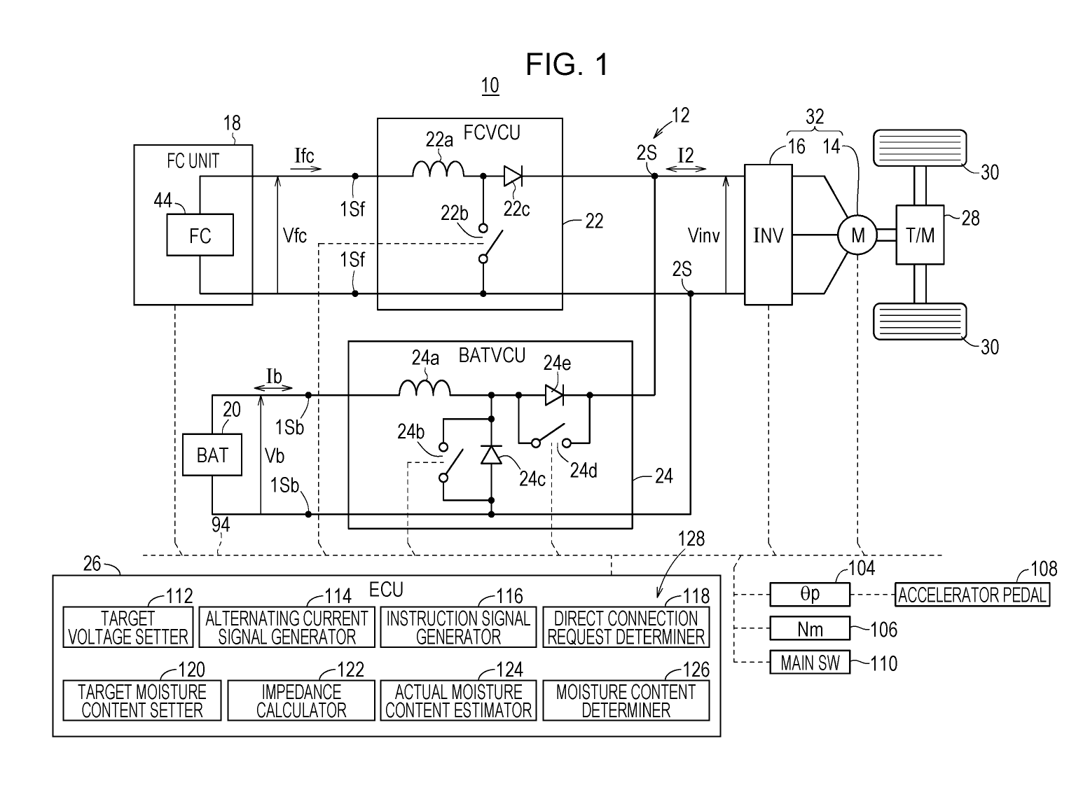

A fuel cell system and a fuel cell vehicle according to embodiments of the present disclosure will herein be described in detail with reference to FIG. 1 to FIG. 6.

### Entire Schematic Configuration of FC Vehicle 10 and FC System 12

FIG. 1 schematically illustrates an example of the entire configuration of a fuel cell vehicle 10 (hereinafter also referred to as an “FC vehicle 10”) according to an embodiment. A fuel cell system 12 (hereinafter also referred to as an “FC system 12”) is applied to the FC vehicle 10.

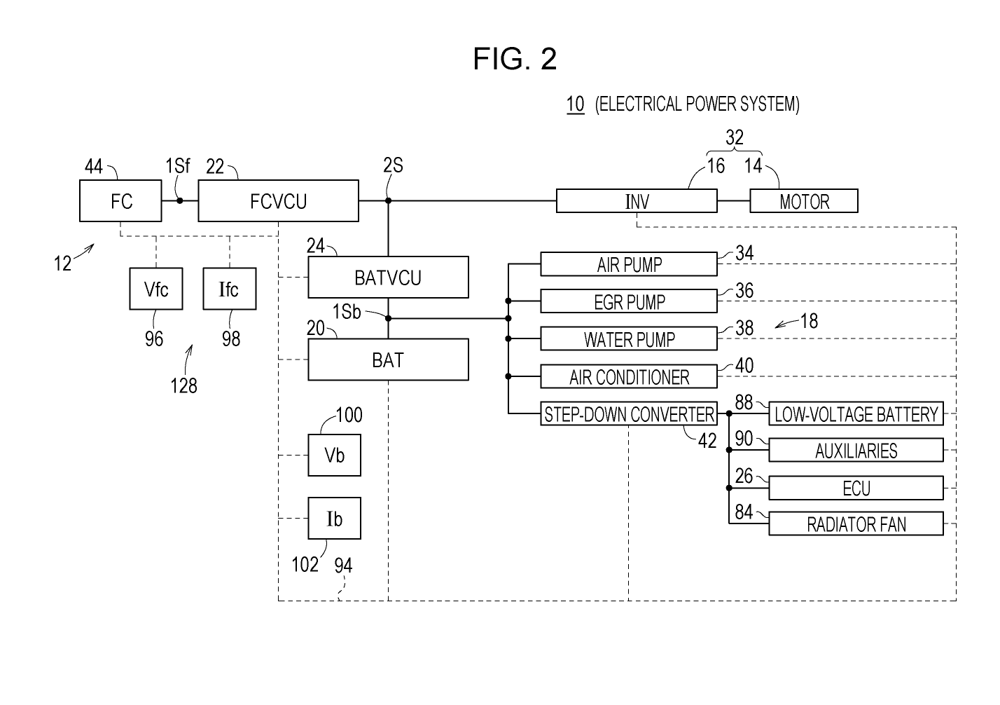

FIG. 2 is a block diagram of an electrical power system of the FC vehicle 10.

As illustrated in FIG. 1 and FIG. 2, the FC vehicle 10 includes the FC system 12, a driving motor 14 (hereinafter also referred to as a “motor 14”), and a load driving circuit 16 (hereinafter also referred to as an “inverter (INV) 16”).

The FC system 12 basically includes a fuel cell unit 18 (hereinafter also referred to as an “FC unit 18”), a high-voltage battery 20 (hereinafter also referred to as a “BAT 20”), a step-up converter 22 (hereinafter also referred to as a “fuel cell voltage control unit (FCVCU) 22”), a step up-down converter 24 (hereinafter referred to as a “BATVCU 24”), and an electronic control unit 26 (hereinafter referred to as an “ECU 26”). The FC unit 18 is disposed at one primary side 1Sf. The BAT 20 is disposed at the other primary side 1Sb. The FCVCU 22 is disposed between the primary side 1Sf and a secondary side 2S. The BATVCU 24 is disposed between the primary side 1Sb and the secondary side 2S. The BATVCU 24 may be a step-up converter.

The motor 14 generates driving force on the basis of power supplied from the FC unit 18 and the BAT 20 and rotates wheels 30 via a transmission 28 using the driving force.

The INV 16 has a three-phase bridge structure. The INV 16 performs direct current-alternating current conversion to convert load drive circuit input end voltage Vinv [V] (hereinafter also referred to as a “load end voltage Vinv”), which is direct current voltage, into three-phase alternating current voltage and supplies the three-phase alternating current voltage to the motor 14. In addition, the INV 16 supplies the load end voltage Vinv after alternating current-direct current conversion involved in a regeneration operation of the motor 14 to the BAT 20 via the BATVCU 24.

A permanent magnet synchronous motor (PM motor) is adopted as the motor 14 in the embodiments. Field-weakening control may be applied in order to increase the number of revolutions of the motor 14 at a certain torque.

The motor 14 and the INV 16 are collectively referred to as a load 32. The load 32 may practically include components including the BATVCU 24, an air pump 34, an exhaust gas recirculation (EGR) pump 36, a water pump 38, an air conditioner 40, and a step-down converter 42, in addition to the motor 14 and so on. The air pump 34, the EGR pump 36, the water pump 38, and the air conditioner 40 are high-voltage auxiliary loads and power is supplied from a fuel cell stack 44 (hereinafter also referred to as an “FC 44”) and/or the BAT 20 to the air pump 34, the EGR pump 36, the water pump 38, and the air conditioner 40.

### Schematic Configuration of FC Unit 18

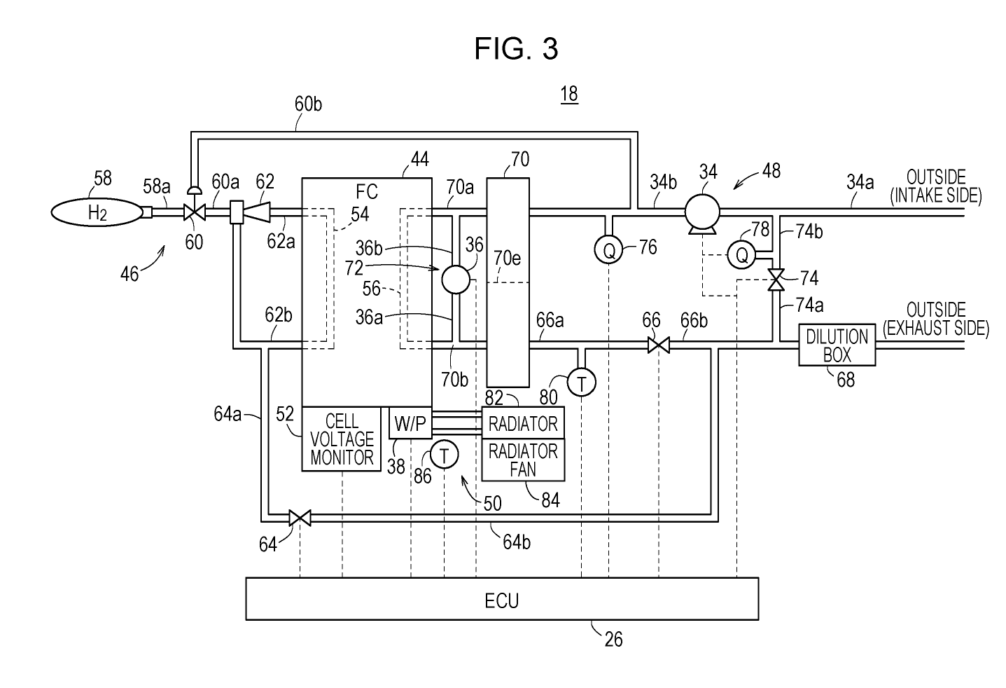

FIG. 3 schematically illustrates an exemplary configuration of the FC unit 18.

The FC unit 18 includes the FC 44, an anode system 46 serving as a fuel gas supplier, a cathode system 48 serving as an oxidant gas supplier, a cooling system 50, and a cell voltage monitor 52. The anode system 46 supplies and exhausts hydrogen (fuel gas) to and from an anode of the FC 44. The cathode system 48 supplies and exhausts air (oxidant gas) including oxygen to a cathode of the FC 44. The cooling system 50 cools down the FC 44.

The FC 44 has, for example, a structure in which fuel battery cells each including a solid polymer electrolyte membrane sandwiched between an anode electrode and a cathode electrode are deposited. Hydrogen supplied to the anode electrode via an anode channel 54 described below is subjected to hydrogen ionization on electrode catalyst and moves to the cathode electrode via the electrolyte membrane. Electrons generated during the movement are extracted into external circuits to generate direct current voltage Vfc (hereinafter also referred to as “FC power generation voltage Vfc”), which is output voltage, and the FC power generation voltage Vfc is used as electrical energy. Since the oxidant gas is supplied to the cathode electrode via a cathode channel 56 described below, the hydrogen ion, the electrons, and the oxygen gas react in the cathode electrode to produce water.

The anode system 46 includes a hydrogen tank 58, a regulator 60, an ejector 62, and a purge valve 64. The hydrogen tank 58 holds hydrogen serving as the fuel gas. The hydrogen tank 58 is connected to an inlet of the anode channel 54 via a pipe 58a, the regulator 60, a pipe 60a, the ejector 62, and a pipe 62a. With this configuration, the hydrogen in the hydrogen tank 58 is capable of being supplied to the anode channel 54 via the pipes 58a, 60a, and 62a. The pipe 58a is provided with a shutoff valve (not illustrated) and the shutoff valve is opened by the ECU 26 in power generation in the FC 44.

The regulator 60 adjusts the pressure of the hydrogen that is received to a predetermined value and exhausts the hydrogen having the pressure of the predetermined value. In other words, the regulator 60 controls the pressure at the downstream side (the pressure of the hydrogen at the anode side) in accordance with the pressure (pilot pressure) of the air at the cathode side, which is input into the regulator 60 via a pipe 60b. Accordingly, the pressure of the hydrogen at the anode side works in conjunction with the pressure of the air at the cathode side. The pressure of the hydrogen at the anode side is also varied in response to variation in the number of rotations, etc. of the air pump 34 for varying the oxygen concentration, as described below.

The ejector 62 jets the hydrogen supplied from the hydrogen tank 58 with a nozzle to generate negative pressure and suctions anode off-gas in a pipe 62b with the negative pressure.

An outlet of the anode channel 54 is connected to an intake port of the ejector 62 via the pipe 62b. The anode off-gas (hydrogen) discharged from the anode channel 54 is input into the ejector 62 again via the pipe 62b for circulation.

The anode off-gas includes hydrogen and water vapor that are not consumed in electrode reaction in the anode. The pipe 62b is provided with a gas liquid separator (not illustrated) which separates and recovers the moisture {condensed water (liquid) and water vapor (gas)} contained in the anode off-gas.

Part of the pipe 62b is connected to a dilution box 68 provided on a pipe 66b described below via a pipe 64a, the purge valve 64, and a pipe 64b. The purge valve 64 is opened for a certain time on the basis of an instruction from the ECU 26 when it is determined that the power generation in the FC 44 is not stable. The dilution box 68 dilutes the hydrogen in the anode off-gas from the purge valve 64 with cathode off-gas (oxidizer-off gas).

The cathode system 48 includes the air pump 34, a humidifier 70, a recirculation mechanism 72 including the EGR pump 36, a back pressure valve 66, a circulation valve 74, flow rate sensors 76 and 78, and a temperature sensor 80.

The air pump 34 compresses outside air (air) serving as supply oxidant gas and supplies the compressed air to the cathode side. An intake port of the air pump 34 is led into the outside of the vehicle via a pipe 34a serving as a supply pipe. A discharge port of the air pump 34 is connected to an inlet of the cathode channel 56 via a pipe 34b, the humidifier 70, and a pipe 70a. Upon actuation of the air pump 34 in response to an instruction from the ECU 26, the air pump 34 suctions the outside air via the pipe 34a and compresses the air. The compressed air is pumped to the cathode channel 56 via the pipe 34b and so on.

The humidifier 70 includes multiple hollow fiber membranes 70e having moisture permeability. The humidifier 70 is in a moisture state (wet state), which is caused by the air toward the cathode channel 56 and the water generated in the cathode electrode, via the hollow fiber membranes 70e. The humidifier 70 performs moisture exchange with the cathode off-gas discharged from the cathode channel 56 to humidify the air toward the cathode channel 56.

A pipe 70b, the humidifier 70, a pipe 66a, the back pressure valve 66, and the pipe 66b are arranged at an outlet side of the cathode channel 56. The cathode off-gas serving as discharge oxidant gas, which is discharged from the cathode channel 56, is discharged to the outside of the vehicle via, for example, the pipes 70b, 66a, and 66b serving as discharge pipes.

The back pressure valve 66 is composed of, for example, a butterfly valve. The valve opening of the back pressure valve 66 is controlled by the ECU 26 to control the pressure of the air in the cathode channel 56. More specifically, in response to decrease in the valve opening of the back pressure valve 66, the pressure of the air in the cathode channel 56 is increased to increase the oxygen concentration (volume concentration) per volume flow rate. In contrast, in response to increase in the valve opening of the back pressure valve 66, the pressure of the air in the cathode channel 56 is decreased to decrease the oxygen concentration (volume concentration) per volume flow rate.

The pipe 66b is connected to the pipe 34a at the upstream side of the air pump 34 via a pipe 74a, the circulation valve 74, and a pipe 74b. Accordingly, part of the discharge gas (cathode off-gas) is supplied to the pipe 34a via the pipe 74a, the circulation valve 74, and the pipe 74b as circulation gas, is combined with new air from the outside, and is pumped by the air pump 34. The circulation valve 74 is composed of, for example, a butterfly valve. The valve opening of the circulation valve 74 is controlled by the ECU 26 to control the flow rate of the circulation gas.

The flow rate sensor 76 is mounted to the pipe 34b. The flow rate sensor 76 detects the flow rate [g/s] of the air toward the cathode channel 56 and supplies the detected flow rate to the ECU 26. The flow rate sensor 78 is mounted to the pipe 74b. The flow rate sensor 78 detects the flow rate [g/s] of the circulation gas toward the pipe 34a and supplies the detected flow rate to the ECU 26.

The temperature sensor 80 is mounted to the pipe 66a. The temperature sensor 80 detects the temperature of the cathode off-gas and supplies the detected temperature to the ECU 26. Since the temperature of the circulation gas is substantially equal to the temperature of the cathode off-gas, the temperature of the circulation gas is capable of being detected on the basis of the temperature of the cathode off-gas detected by the temperature sensor 80.

The recirculation mechanism 72 composed of the EGR pump 36 and pipes 36a and 36b is disposed between the humidifier 70 and the cathode side of the FC 44. As described above, the cathode off-gas is in the wet state due to the power generation in the FC 44. Upon actuation of the EGR pump 36 in response to an instruction from the ECU 26, the EGR pump 36 returns part of the cathode off-gas discharged from the cathode channel 56 into the pipe 70a via the pipes 36a and 36b. Part of the cathode off-gas that is returned is combined with the air passing through the humidifier 70 and is supplied to the cathode channel 56 again. As a result, the amount of moisture to be supplied to the cathode side of the FC 44 is capable of being increased.

The cooling system 50 includes the water pump 38, a radiator 82, a radiator fan 84, a temperature sensor 86, and so on. The water pump 38 circulates cooling water (refrigerant) in the FC 44 to cool down the FC 44. The cooling water the temperature of which is increased by the cooling down of the FC 44 is heat-dissipated by the radiator 82 that receives air flow from the radiator fan 84. The temperature sensor 86 detects the temperature of the cooling water and supplies the detected temperature to the ECU 26.

The cell voltage monitor 52 detects cell voltage Vcell of each of multiple cells composing the FC 44. The cell voltage monitor 52 includes a monitor body and a wire harness that connects the monitor body to each cell. The monitor body scans all the cells on a predetermined cycle and detects the cell voltage Vcell of each cell to calculate average cell voltage and minimum cell voltage. The average cell voltage and the minimum cell voltage that are calculated are supplied to the ECU 26.

### Schematic Configuration of Electrical Power System of Fuel Cell Vehicle 10 and Fuel Cell System 12

Referring back to FIG. 1 and FIG. 2, the power generated by the FC 44 (hereinafter also referred to as “FC power Pfc”) (Pfc=Vfc×Ifc, Ifc: FC power generation current) is supplied to the INV 16 and the motor 14 composing the load 32 (during powering) in response to stepping up of the FC power generation voltage Vfc by the FCVCU 22 serving as a voltage adjustment unit or setting of the FCVCU 22 to a direct connection state.

The FC power Pfc is supplied to the auxiliaries including the air pump 34, the EGR pump 36, the water pump 38, and the air conditioner 40 via the BATVCU 24 depending on the power status in the FC system 12. In addition, the FC power Pfc is supplied to the BAT 20 for charge via the BATVCU 24 depending on the power status in the FC system 12. Furthermore, the FC power Pfc is supplied to a low-voltage battery 88, auxiliaries 90 including lights, accessories, and various sensors, which are driven with low voltage, the ECU 26, the radiator fan 84, and so on via the BATVCU 24 and the step-down converter 42 depending on the power status in the FC system 12.

The power from the BAT 20 (hereinafter also referred to as “BAT voltage Pbat”) is supplied to the INV 16 and the motor 14 in response to stepping up of battery voltage Vb by the BATVCU 24 or setting of the BATVCU 24 to the direct connection state (during the powering). The BAT power Pbat is supplied to the auxiliaries including the air pump 34 and is supplied to the low-voltage battery 88 and so on via the step-down converter 42 depending on the power status in the FC system 12. The power from the low-voltage battery 88 is supplied to the auxiliaries 90, the ECU 26, the radiator fan 84, and so on.

The BAT 20 is an electrical storage device (energy storage) including multiple battery cells. For example, a lithium ion secondary battery, a nickel-metal-hydride secondary battery, or a capacitor may be used as the BAT 20. The lithium ion secondary battery is used as the BAT 20 in the embodiments.

As schematically illustrated in FIG. 1, the FCVCU 22 includes an inductor 22a, a switching element 22b, and a diode 22c. The FCVCU 22 steps up the FC power generation voltage Vfc to a certain load end voltage Vinv in response to setting of the switching element 22b to a switching state (duty control) via the ECU 26.

When the switching element 22b is kept in an off state (open state), the switching element 22b is in a state in which the switching element 22b does not perform the switching operation, the FC 44 is directly connected to the load 32 via the inductor 22a and the diode 22c, and the load end voltage Vinv is directly connected to the FC power generation voltage Vfc (Vinv=Vfc−Vd≈Vfc, Vd<<Vfc, Vd: forward drop voltage of the diode 22c). In this case, the diode 22c operates for voltage step-up or direct connection and for backflow prevention. Accordingly, the FCVCU 22 performs the backflow prevention operation and the direct connection operation (for example, during the powering), in addition to the voltage step-up operation (for example, during the powering).

The BATVCU 24 includes an inductor 24a, switching elements 24b and 24d, and diodes 24c and 24e connected in parallel to the switching elements 24b and 24d, respectively. In this case, during the voltage step-up, the switching element 24d is set to the off state and the switching element 24b is switched on (duty control) by the ECU 26 to step up the battery voltage Vb (storage voltage) to a certain load end voltage Vinv (during the powering).

During the voltage step-down, the switching element 24b is set to the off state and the switching element 24d is switched on (duty control) by the ECU 26 to step down the load end voltage Vinv to the battery voltage Vb of the BAT 20 (during regeneration charge or during charge by the FC 44). When the switching element 24b is set to the off state and the switching element 24d is set to the on state, the BAT 20 is directly connected to the load 32 (referred to as a BAT direct connection state: during the powering, during the charge, or during the driving of the auxiliary loads and so on).

In the BAT direct connection state, the battery voltage Vb of the BAT 20 is equal to the load end voltage Vinv (Vb=Vinv). Practically, the load end voltage Vinv during the powering by the BAT 20 in the BAT direct connection state is equal to “Vb−the forward drop voltage of the diode 24e” and the load end voltage Vinv during the charge (including the regeneration) is equal to “Vb+the on voltage of the switching element 24d=Vb (provided that the on voltage of the switching element 24d is 0[V]).

Smoothing capacitors disposed at the primary side 1Sf, the primary side 1Sb, and the secondary side 2S are omitted in the FCVCU 22 and the BATVCU 24 in FIG. 1.

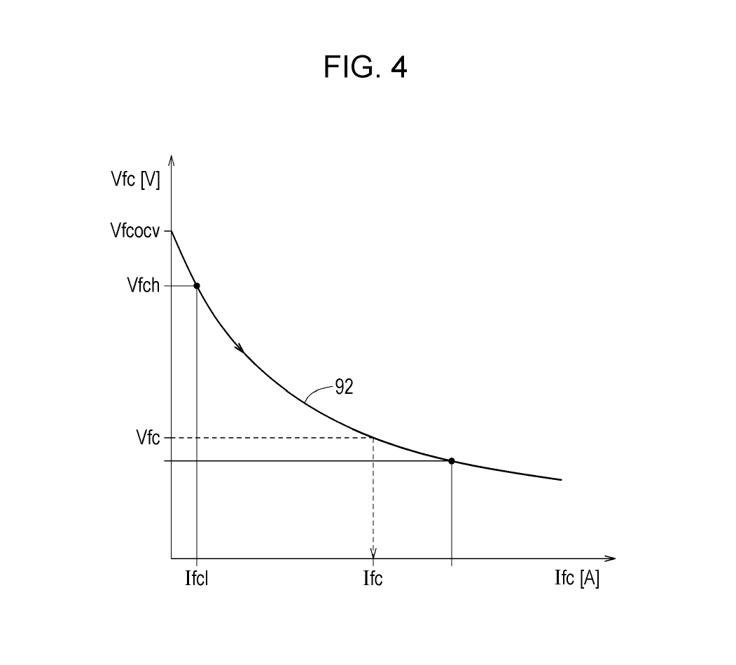

As illustrated in FIG. 4, the FC 44 has a known current voltage (IV) characteristic 92 in which the FC current Ifc, which is output current, is increased as the FC voltage Vfc is decreased from FC open end voltage Vfcocv.

Accordingly, in the direct connection state of the FCVCU 22, the FC power generation voltage Vfc of the FC 44 is controlled by the load end voltage Vinv (instruction voltage (target voltage) of the BATVCU 24) determined by a step-up ratio (Vinv/Vb) of the BATVCU 24 in the step-up state (switching state). Accordingly, upon determination of the FC power generation voltage Vfc, the FC power generation current Ifc is controlled (determined) along the IV characteristic 92.

In the step-up state of the FCVCU 22, the voltage at the primary side 1Sf of the FCVCU 22, that is, the FC power generation voltage Vfc is set as instruction voltage (target voltage) of the FCVCU 22 and the FC power generation current Ifc is determined along the IV characteristic 92. A step-up ratio (Vinv/Vfc) of the FCVCU 22 is determined so as to generate a desired load end voltage Vinv.

In the direct connection state of the BATVCU 24 during the regeneration, the FC power generation voltage Vfc of the FC 44 is set as the instruction voltage (target voltage) of the FCVCU 22. The step-up ratio (Vinv/Vfc) of the FCVCU 22 is determined so as to be varied with the variation in the load end voltage Vinv and the FC power generation current Ifc is controlled (determined) along the IV characteristic 92.

In the direct connection state of the BATVCU 24 during the powering, the FC power generation voltage Vfc of the FC 44 is set as the instruction voltage (target voltage) of the FCVCU 22. The step-up ratio (Vinv/Vfc) of the FCVCU 22 is determined so as to be varied with the variation in the load end voltage Vinv and the FC power generation current Ifc is controlled (determined) along the IV characteristic 92.

A simultaneous direct connection state in which the FCVCU 22 and the BATVCU 24 are simultaneously in the direct connection state is avoided because the simultaneous direct connection state of the FCVCU 22 and the BATVCU 24 may disable the control of the load end voltage Vinv and/or may deteriorate or damage the FC 44 and the BAT 20.

In the embodiments, during the powering in which motor request power Pmotreq is positive, the FCVCU 22 is set to the direct connection state and the load end voltage Vinv, which has been set to the FC power generation voltage Vfc, is set to load end instruction voltage Vinvcom, which is the instruction voltage (target voltage) of the BATVCU 24. In this case, the load end instruction voltage Vinvcom is decreased as the motor request power Pmotreq is increased in a positive direction. In other words, the decrease in the FC power generation voltage Vfc increases the FC power generation current Ifc (increases the FC power Pfc) and the FC power Pfc is supplied to the motor 14 via the INV 16. The BAT 20 is charged with the FC power Pfc via the BATVCU 24 and the FC power Pfc is supplied to the auxiliaries including the air pump 34.

During the regeneration in which the motor request power Pmotreq is negative, the FC power generation voltage Vfc is set to FC power generation voltage Vfch of a relatively high constant value at which the FC power generation current Ifc is equal to FC power generation current Ifcl of a relatively low value (refer to FIG. 4) in order to take regeneration power into the BAT 20 as much as possible (in order to increase the amount of charge). Here, when the battery voltage Vb is lower than or equal to the FC power generation voltage Vfc (Vb Vfc), the target voltage (the secondary side voltage) of the BATVCU 24 is set to the load end instruction voltage Vinvcom and the FC power generation voltage Vfc is fixed to the FC power generation voltage Vfch.

Even during the regeneration in which the motor request power Pmotreq is negative, if the battery voltage Vb exceeds the FC power generation voltage Vfc (Vb>Vfc), the BATVCU 24 is switched from the switching state (voltage control state) to the direct connection state in order to take the regeneration power into the BAT 20 as much as possible (in order to increase the amount of charge). Then, the load end instruction voltage Vinvcom is set to the battery voltage Vb and the battery voltage Vb is gradually increased along with the charge with the regeneration power.

In synchronization with the switching from the switching state (voltage control state) to the direct connection state of the BATVCU 24, the FCVCU 22 is switched from the direct connection state to the switching state (voltage control state). Control of the secondary side voltage in the switching state (voltage control state) of the FCVCU 22 allows the load end instruction voltage Vinvcom to be increased and allows the battery voltage Vb to be sequentially increased with the increase in the load end instruction voltage Vinvcom.

The ECU 26 controls the motor 14, the INV 16, the FC unit 18, the BAT 20, FCVCU 22, and BATVCU 24 via a communication line 94 (refer to FIG. 1 and FIG. 2). In the control, the ECU 26 executes programs stored in a memory (read only memory (ROM)) (not illustrated) and uses the values detected by the various sensors. The values detected by the various sensors include the FC power generation voltage Vfc of the FC 44, the FC power generation current Ifc, an FC temperature Tfc (for example, the temperature of the refrigerant flowing through the water pump 38), the battery voltage Vb of the BAT 20, battery current Ib, a battery temperature Tb, the load end voltage Vinv of the INV 16, secondary current I2, motor current Im, and a motor temperature Tm.

The various sensors include a position sensor 104 and a number-of-revolutions-of-motor sensor 106, in addition to a voltage sensor 96 that detects the FC power generation voltage Vfc, a current sensor 98 that detects the FC power generation current Ifc, a voltage sensor 100 that detects the battery voltage Vb, and a current sensor 102 that detects the battery current Ib. The position sensor 104 detects the degree of opening Op [deg] of an accelerator pedal 108. The number-of-revolutions-of-motor sensor 106 detects the number of revolutions of the motor 14 (hereinafter referred to as the “number of revolutions of the motor Nm” or the “number of revolutions Nm”) [rpm].

The ECU 26 detects a vehicle speed V [km/h] of the FC vehicle 10 on the basis of the number of revolutions Nm. Although the number-of-revolutions-of-motor sensor 106 also serves as a vehicle speed sensor in the FC vehicle 10, the vehicle speed sensor may be separately provided.

A main switch 110 (hereinafter referred to as a “main SW 110”) is also connected to the ECU 26. The main switch 110 corresponds to an ignition switch of an internal combustion engine automobile. The main switch 110 is used to switch between supply of power from the FC unit 18 to the motor 14 and supply of power from the BAT 20 to the motor 14. The main switch 110 is capable of being operated by a user. The FC 44 is in a power generation state when the main switch 110 is turned on and the FC 44 is in a power generation stop state when the main switch 110 is turned off.

The ECU 26 is a calculating machine including a microcomputer. The ECU 26 includes a central processing unit (CPU), a read only memory (ROM) (including an electrically erasable and programmable ROM (EEPROM)), a random access memory (RAM), input-output units including an analog-to-digital (A/D) converter and a digital-to-analog (D/A) converter, a timer serving as a time register, and so on. The CPU reads out the programs stored in the ROM and executes the programs to cause the ECU 26 to function as various function realizing components including a controller, an arithmetic portion, and a processor. The ECU 26 may not be composed of one ECU and may be composed of multiple ECUs including an ECU for the motor 14, an ECU for the FC unit 18, an ECU for the BAT 20, an ECU for the FCVCU 22, and an ECU for the BATVCU 24.

The ECU 26 determines the load to be allocated to the FC 44, the load to be allocated to the BAT 20, and the load to be allocated to the regeneration power source (the motor 14) from the loads requested for the FC system 12 as the entire FC vehicle 10, which are determined on the basis of the inputs (load requests) from the various switches and the various sensors, in addition to the state of the FC 44, the state of the BAT 20, and the state of the motor 14, and supplies instructions to the motor 14, the INV 16, the FC unit 18, the BAT 20, the FCVCU 22, and the BATVCU 24.

### Characteristic Function (Configuration) of Fuel Cell Vehicle 10 and Fuel Cell System 12

A characteristic function (configuration) of the FC vehicle 10 and the FC system 12 according to the embodiments will now be described.

The characteristic function of the embodiments is, when the FCVCU 22 is switched to the direct connection state after stepping up or down the FC power generation voltage Vfc by the FCVCU 22, making the actual moisture content in the FC 44 higher than the normal moisture content during a time period of a step up-down operation (switching operation) immediately before the FCVCU 22 is switched to the direct connection state.

In order to achieve this function, the ECU 26 includes a target voltage setter 112, an alternating current signal generator 114, an instruction signal generator 116, a direct connection request determiner 118, a target moisture content setter 120, an impedance calculator 122, an actual moisture content estimator 124, and a moisture content determiner 126. The voltage sensor 96, the current sensor 98, the impedance calculator 122, and the actual moisture content estimator 124 compose a moisture content detecting unit 128 that detects the actual moisture content in the FC 44.

The target voltage setter 112 sets a target value (target voltage) of the FC power generation voltage Vfc. As described above, the target value (target voltage) is determined by the step-up ratio and the like. The alternating current signal generator 114 generates an alternating current signal to be applied to the FC 44 for detecting the actual moisture content. The alternating current signal is preferably an alternating current signal (sinusoidal signal) having an amplitude and a frequency that do not affect the control of the FC system 12 by the ECU 26. The instruction signal generator 116 superimposes the alternating current signal generated by the alternating current signal generator 114 on the target voltage set by the target voltage setter 112 and outputs the voltage (signal) resulting from the superimposition as an instruction signal (instruction voltage). Accordingly, the ECU 26 is capable of supplying the instruction signal generated by the instruction signal generator 116 as an instruction signal for the FCVCU 22 to the FCVCU 22 via the communication line 94.

The FCVCU 22 performs the step up-down operation to the FC power generation voltage Vfc on the basis of the target voltage in the instruction signal supplied via the communication line 94 and causes the switching element 22b to perform the switching operation on the basis of the alternating current signal in the instruction signal to generate alternating current voltage and apply the generated alternating current voltage to the FC 44.

Accordingly, the voltage sensor 96 detects the FC power generation voltage Vfc including the alternating current voltage (alternating current signal component) applied to the FC 44 and supplies the result of the detection to the ECU 26 via the communication line 94. The current sensor 98 detects the FC power generation current Ifc including the alternating current voltage (alternating current signal component) flowing through the FC 44 due to the application of the alternating current voltage and supplies the result of the detection to the ECU 26 via the communication line 94.

The impedance calculator 122 calculates the impedance in the FC 44 on the basis of the alternating current signal component in the FC power generation voltage Vfc included in the result of the detection by the voltage sensor 96 and the alternating current signal component in the FC power generation current Ifc included in the result of the detection by the current sensor 98 {(the impedance in the FC 44)=(the alternating current signal component of Vfc)/(alternating current signal component of Ifc)}.

The actual moisture content estimator 124 estimates the actual moisture content in the FC 44 on the basis of the impedance calculated by the impedance calculator 122. In this case, the actual moisture content estimator 124 may hold, for example, a map indicating the relationship between the impedance and the actual moisture content in advance and may identify the actual moisture content corresponding to the impedance calculated by the impedance calculator 122 using the map to estimate the actual moisture content.

Accordingly, the ECU 26 is capable of controlling the FC unit 18, the FCVCU 22, and so on in consideration of the value of the actual moisture content estimated by the actual moisture content estimator 124.

The direct connection request determiner 118 determines that the FCVCU 22 should be switched from the step up-down state to the direct connection state if the motor request power Pmotreq is lower than or equal to a predetermined threshold value (hereinafter also referred to as a “direct connection threshold value Pmotth”).

From the viewpoint of the efficiency of the FC system 12, it is desirable that the switching operation of the FCVCU 22 be stopped to directly connect the FC 44 to the INV 16 in order to reduce the loss caused by the switching operation. In addition, since the increase in the actual moisture content increases the FC power generation voltage Vfc, setting the FCVCU 22 to the direct connection state after increasing the FC power generation voltage Vfc causes the high FC power generation voltage Vfc to be directly applied to the INV 16 as the load end voltage Vinv. As a result, the loss in the load 32 is reduced to improve the efficiency of the load 32.

However, when the switching operation is stopped, the FCVCU 22 is not capable of generating the alternating current voltage to apply the alternating current voltage to the FC 44. This disables the detection of the alternating current signal components of the FC power generation voltage Vfc and the FC power generation current Ifc to disable the calculation of the impedance in the FC 44 and the estimation of the actual moisture content.

Accordingly, when the FCVCU 22 stops the switching operation, the ECU 26 is not capable of appropriately controlling the FC system 12 on the basis of the actual moisture content. Consequently, excessive reduction in the amount of moisture (actual moisture content) in the FC 44 deteriorates the electrolyte membrane, reduces the IV characteristic 92 of the FC 44, and reduces the power generation efficiency. As a result, the efficiency of the entire FC system 12 may possibly be reduced.

In contrast, continuing the operation of the FC system 12 in a state in which the actual moisture content is increased from the beginning causes a problem of, for example, an increase in frequency of the sintering of the electrode catalyst caused by the increase in the amount of moisture to reduce the durability of the FC 44.

In order to prevent the above problems from occurring, the target moisture content setter 120 sets the target value (target moisture content) of the actual moisture content in the FC 44 at the time when the FCVCU 22 is set to the direct connection state if the direct connection request determiner 118 determines that the FCVCU 22 should be switched to the direct connection state. In this case, the target moisture content preferably has a relatively high value that suppresses the reduction in the IV characteristic 92 when the FCVCU 22 is set to the direct connection state. For example, the target moisture content preferably has a value that does not cause the deterioration of the electrolyte membrane, etc. even if the actual moisture content is reduced after the FCVCU 22 is set to the direct connection state and the IV characteristic 92 is slightly reduced.

Accordingly, when the direct connection request determiner 118 determines that the FCVCU 22 should be switched from the step-up state to the direct connection state and the target moisture content setter 120 sets the target moisture content, the ECU 26 controls the FC unit 18, the FCVCU 22, and so on so that the actual moisture content in the FC 44 reaches the target moisture content at the time when the FCVCU 22 is set to the direct connection state.

The moisture content determiner 126 determines whether the actual moisture content in the FC 44 is increased to the target moisture content. If the moisture content determiner 126 determines that the actual moisture content in the FC 44 reaches the target moisture content, the ECU 26 controls the FCVCU 22 so as to be in the direct connection state.

### Description of how to Control FC System 12 by ECU 26

The FC vehicle 10 and the FC system 12 according to the embodiments are configured in the following manner.

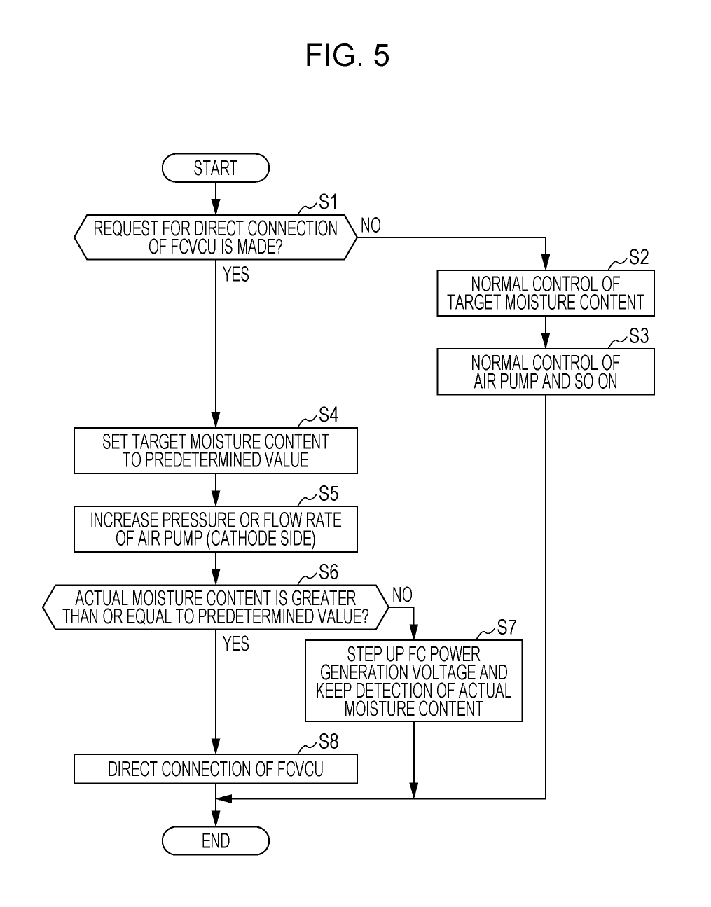

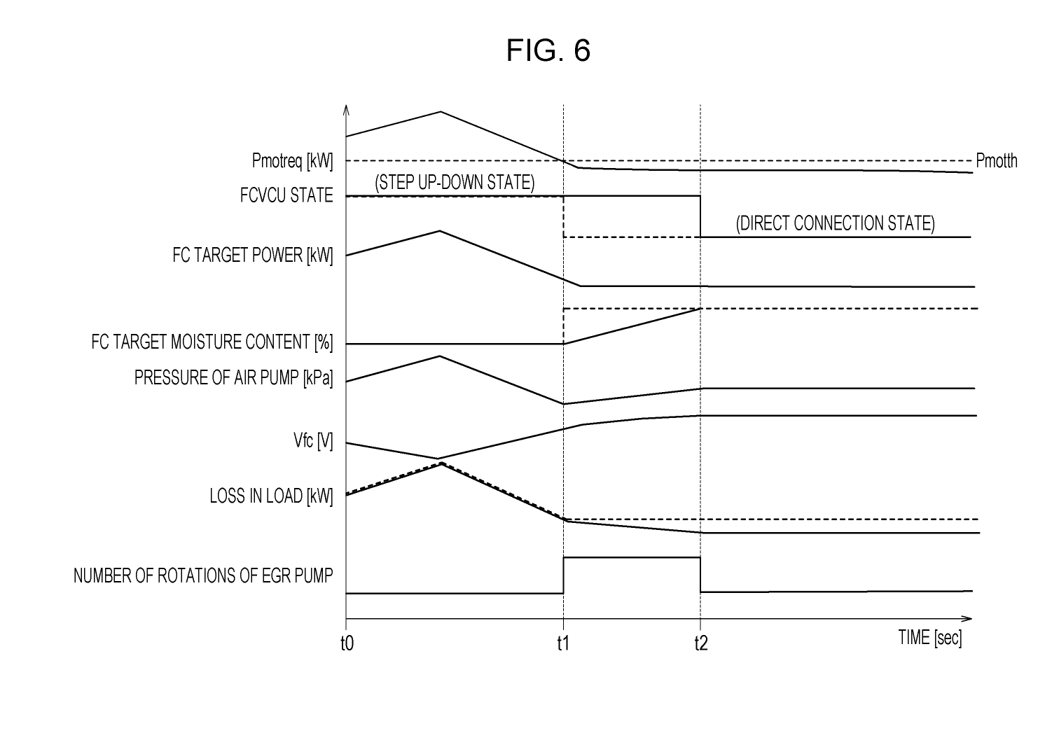

How to control the FC system 12 by the ECU 26, specifically, an exemplary control operation process by the ECU 26 when the FCVCU 22 in the step up-down state is switched to the direct connection state will now be described as an exemplary operation of the FC vehicle 10 and the FC system 12 with reference to a flowchart in FIG. 5 and a timing chart in FIG. 6. The control operation process is described also with reference to FIG. 1 to FIG. 4, as needed.

How to control the FC unit 18 and the FCVCU 22 will be mainly described and a description of how to control the BATVCU 24 is omitted herein. The BATVCU 24 is kept in the step up-down state, for example, in the time period in the flowchart in FIG. 5 and the timing chart in FIG. 6.

The processing in FIG. 5 is repeatedly performed in the time period in the timing chart in FIG. 6.

Referring to FIG. 5, in Step S1, the direct connection request determiner 118 in the ECU 26 determines whether the motor request power Pmotreq [kW], which is request power from the load 32, is lower than or equal to the threshold value Pmotth (Pmotreq Pmotth), that is, whether the FCVCU 22 should be switched from the step up-down state to the direct connection state.

If the motor request power Pmotreq exceeds the threshold value Pmotth (NO in Step S1, during a time period from a time t0 to a time t1), in Step S2, the target moisture content setter 120 in the ECU 26 sets an appropriate target moisture content (a desired target moisture content corresponding to the motor request power Pmotreq) when the FCVCU 22 is in the step up-down state. The ECU 26 controls the target voltage setter 112, the alternating current signal generator 114, and the instruction signal generator 116 on the basis of, for example, the target moisture content that is set and the motor request power Pmotreq.

The target voltage setter 112, the alternating current signal generator 114, and the instruction signal generator 116 set the target voltage in the step up-down state, the alternating current signal, and the instruction signal, respectively. Accordingly, the ECU 26 is capable of causing the FCVCU 22 to perform the step up-down operation by supplying the instruction signal generated by the instruction signal generator 116 to the FCVCU 22 via the communication line 94.

The FCVCU 22 generates the alternating current voltage in conjunction with the step up-down operation and applies the generated alternating current voltage to the FC 44. Accordingly, the voltage sensor 96 is capable of detecting the FC power generation voltage Vfc including the alternating current signal component and the current sensor 98 is capable of detecting the FC power generation current Ifc including the alternating current signal component. As a result, the impedance calculator 122 is capable of calculating the impedance in the FC 44 on the basis of the alternating current signal components and the actual moisture content estimator 124 is capable of estimating the actual moisture content in the FC 44 on the basis of the calculated impedance.

In Step S3, the ECU 26 controls the FC unit 18 so that the actual moisture content in the FC 44 reaches the target moisture content on the basis of the target moisture content that is set, the motor request power Pmotreq, and so on. For example, the control of the air pump 34 by the ECU 26 via the communication line 94 allows the air pump 34 to supply the air of an appropriate amount of supply or of an appropriate supply pressure corresponding to the target moisture content to the cathode channel 56.

As a result, during the time period from the time t0 to the time t1, the FCVCU 22 is kept in the step up-down state. The FC power Pfc, the FC power generation voltage Vfc, the pressure of the air supplied from the air pump 34 to the cathode channel 56, and the loss in the load 32 are varied with the motor request power Pmotreq. The actual moisture content in the FC 44 is varied with the target moisture content. The EGR pump 36 may rotate at a certain number of rotations or may stop the rotation.

If the direct connection request determiner 118 determines in Step S1 that the motor request power Pmotreq is lower than or equal to the threshold value Pmotth (Pmotreq Pmotth) at the time t1 (YES in Step S1), the direct connection request determiner 118 determines that the FCVCU 22 should be switched from the step up-down state to the direct connection state. In Step S4, the target moisture content setter 120 sets an appropriate target moisture content at the time when the FCVCU 22 is set to the direct connection state also in consideration of the motor request power Pmotreq.

In Step S5, the ECU 26 increases the pressure or the amount of supply of the air to be supplied from the air pump 34 to the cathode channel 56 to control the FC unit 18 so that the actual moisture content in the FC 44 is increased to the target moisture content set by the target moisture content setter 120. In this case, the ECU 26 may increase the number of rotations of the EGR pump 36, instead of the air pump 34, to increase the actual moisture content.

In Step S6, the moisture content determiner 126 determines whether the actual moisture content reaches the target moisture content through the control process in Step S5. If the moisture content determiner 126 determines that the actual moisture content does not reach the target moisture content (actual moisture content<target moisture content) (NO in Step S6), in Step S7, the ECU 26 controls the target voltage setter 112 so as to set a higher target voltage in order to step up the FC power generation voltage Vfc by the FCVCU 22 and controls the alternating current signal generator 114 so as to generate the alternating current signal in order to continue the detection of the actual moisture content.

The instruction signal generator 116 superimposes the alternating current signal generated by the alternating current signal generator 114 on the higher target voltage set by the target voltage setter 112 to generate a new instruction signal. The ECU 26 supplies the new instruction signal to the FCVCU 22 via the communication line 94 and the FCVCU 22 causes the switching element 22b to perform the switching operation on the basis of the new instruction signal. As a result, the FCVCU 22 generates the alternating current voltage and applies the alternating current voltage to the FC 44 while stepping up the FC power generation voltage Vfc.

Accordingly, in response to the detection of the FC power generation voltage Vfc by the voltage sensor 96 and the detection of the FC power generation current Ifc by the current sensor 98, the impedance calculator 122 is capable of calculating the impedance in the FC 44 and the actual moisture content estimator 124 is capable of calculating the actual moisture content from the calculated impedance.

As described above, since the control process in the flowchart in FIG. 5 is repeatedly performed, Steps S1 and S4 to S7 are repeatedly performed in the ECU 26 until the actual moisture content reaches the target moisture content during a time period from the time t1 to a time t2.

Since the actual moisture content does not reach the target moisture content during the time period from the time t1 to the time t2, the ECU 26 causes the FCVCU 22 to continue the step-up operation even if the direct connection request determiner 118 determines that the FCVCU 22 should be set to the direct connection state (YES in Step S1). In “FCVCU state” in FIG. 6, the result of the determination by the direct connection request determiner 118 is denoted by a broken line and the actual operation state of the FCVCU 22 is denoted by a solid line.

In addition, during the time period from the time t1 to the time t2, the actual moisture content is increasing toward the target moisture content with time. In “FC target moisture content” in FIG. 6, the target moisture content is denoted by a broken line and the actual moisture content is denoted by a solid line.

As described above, in order to increase the actual moisture content to the target moisture content, during the time period from the time t1 to the time t2, the supply pressure of the air to be supplied from the air pump 34 to the cathode channel 56 is increased with time and the number of rotations of the EGR pump 36 is fixed to a large number.

The FC power generation voltage Vfc is stepped up with time due to the step-up operation of the FCVCU 22, the increase in the supply pressure of the air, and the increase in the number of rotations of the EGR pump 36 during the time period from the time t1 to the time t2 and the stepped-up FC power generation voltage Vfc is applied to the INV 16 as the load end voltage Vinv to reduce the loss in the load 32. In “Loss in load” in FIG. 6, the loss in the load 32 when the control process in FIG. 5 is performed is denoted by a solid line and the loss in the load 32 when the control process in FIG. 5 is not performed is denoted by a broken line.

If the moisture content determiner 126 determines in Step S6 that the actual moisture content reaches the target moisture content (YES in Step S6, at the time t2) when the control process in FIG. 5 is performed again, in Step S8, the ECU 26 instructs the FCVCU 22 to switch to the direct connection state via the communication line 94. The FCVCU 22 stops the switching operation with the switching element 22b and causes the FC 44 to be directly connected to the INV 16 via the inductor 22a and the diode 22c.

As a result, since the FCVCU 22 does not generate the alternating current voltage and does not apply the alternating current voltage to the FC 44 after the time t2, the impedance calculator 122 is not capable of calculating the impedance in the FC 44 using the results of the detection by the voltage sensor 96 and the current sensor 98. Accordingly, the actual moisture content estimator 124 is not capable of estimating the actual moisture content in the FC 44. Consequently, after the time t2, the ECU 26 is not capable of controlling the FCVCU 22 and the FC unit 18 in consideration of the actual moisture content.

However, as described above, the FCVCU 22 is set to the direct connection state after the target moisture content at the time of the direct connection state is set in consideration of the reduction in the actual moisture content caused by the direct connection state of the FCVCU 22 and the actual moisture content is increased to the target moisture content that is set. Accordingly, even if the actual moisture content is decreased after the time t2, it is possible to suppress occurrences of the reduction in the IV characteristic 92 and the deterioration of the electrolyte membrane.

Referring to FIG. 6, after the time t2, the supply pressure of the air to be supplied from the air pump 34 to the cathode channel 56 is kept at a certain pressure, the FC power generation voltage Vfc is kept at a certain voltage, the loss in the load 32 is kept at a certain value, and the number of rotations of the EGR pump 36 is returned to the number of rotations during the time period from the time t0 to the time t1.

### Advantages of Embodiments

In the FC vehicle 10 and the FC system 12 according to the embodiments, the ECU 26 increases the actual moisture content before the FCVCU 22 is set to the direct connection state. In other words, in the above embodiments, the FCVCU 22 is set to the direct connection state after the actual moisture content is increased in advance immediately before the FCVCU 22 is set to the direct connection state to make the actual moisture content higher than the actual moisture content during the normal operation.

With the above configuration, even if the switching operation with the switching element 22b in the FCVCU 22 (the step up-down operation of the FCVCU 22) is stopped to disable the detection of the actual moisture content, it is possible to suppress the reduction in the IV characteristic 92 of the FC 44 caused by the reduction in the actual moisture content in the direct connection state. Since the actual moisture content is increased immediately before the FCVCU 22 is set to the direct connection state, it is possible to suppress the increase in frequency of the sintering of the electrode catalyst to ensure the durability of the FC 44.

Accordingly, in the above embodiments, it is possible to easily provide two advantages: the reduction in the loss in the FCVCU 22 due to the direct connection state of the FCVCU 22 and the reduction in the loss in the load 32 due to the increase in the moisture content. Consequently, it is possible to improve the efficiency of the entire FC system 12, which includes the power generation efficiency of the FC 44.

As a result, if the load 32 in the FC system 12 includes the motor 14 of the FC vehicle 10 when the FC system 12 is applied to the FC vehicle 10, it is possible to easily improve the mileage performance of the FC vehicle 10 in conjunction with the improvement in the efficiency of the entire FC system 12.

The control of the air pump 34 by the ECU 26 to increase the supply pressure or the amount of supply of the air to be supplied to the cathode channel 56 in the FC 44 allows the actual moisture content to be increased, thereby easily increasing the FC power generation voltage Vfc. Setting the FCVCU 22 to the direct connection state after increasing the FC power generation voltage Vfc causes the high FC power generation voltage Vfc to be directly supplied to the load 32 as the load end voltage Vinv. Accordingly, it is possible to reduce the loss in the load 32 to improve the efficiency of the load 32.

The case is described above in which the actual moisture content is increased by increasing the supply pressure or the amount of supply of the air to be supplied from the air pump 34 to the cathode channel 56. However, any method may be adopted in the above embodiments as long as the actual moisture content is increased.

For example, the ECU 26 may increase the actual moisture content by increasing the supply pressure or the amount of supply of the hydrogen to be supplied from the hydrogen tank 58 to the anode channel 54 to increase the amount of moisture in the FC 44.

The ECU 26 may increase the actual moisture content by increasing the amount of power generation in the FC 44 to increase the amount of moisture generated in the FC 44. In this case, since the FC 44 generates the power higher than the motor request power Pmotreq that is originally requested, the BAT 20 may be charged with excess power that is not consumed in the load 32.

The ECU 26 may increase the actual moisture content by operating the EGR pump 36 to return the cathode off-gas to the pipe 70a and/or humidifying the air with the humidifier 70 to increase the amount of humidification of the air to be supplied to the cathode channel 56.

The ECU 26 may increase the actual moisture content by decreasing the flow rate of the air to be supplied to the cathode channel 56 through the control the air pump 34 to suppress discharge of the moisture from the outlet of the cathode channel 56.

The ECU 26 may increase the actual moisture content by operating the water pump 38 and the radiator fan 84 to decrease the temperature of the cooling water for cooling down the FC 44 in order to facilitate liquefaction of the moisture in the FC 44.

The ECU 26 may increase the actual moisture content by jetting the moisture by injection in the humidifier 70 to supply the humidified air including the jetted moisture to the cathode channel 56.

Since the actual moisture content is increased in any case, it is possible to easily increase the FC power generation voltage Vfc.

The ECU 26 sets the FCVCU 22 to the direct connection state after the step up-down operation of the FC power generation voltage Vfc by the FCVCU 22 is continued until the moisture content determiner 126 determines that the actual moisture content is increased to the target moisture content. Accordingly, the FCVCU 22 is kept in the step-up state for a certain time before the actual moisture content reaches the target moisture content and priority is given to the detection of the actual moisture content by the moisture content detecting unit 128. Setting the FCVCU 22 to the direct connection state when the actual moisture content reaches the target moisture content allows the reduction in the IV characteristic 92 of the FC 44 to be effectively suppressed.

The ECU 26 increases the supply pressure or the amount of supply of the air through the control of the air pump 34 and adjusts the amount of supply of the anode off-gas to be supplied to the pipe 70a through the control of the EGR pump 36 in the recirculation mechanism 72. Accordingly, it is possible to efficiently increase the actual moisture content to the target moisture content before the FCVCU 22 is set to the direct connection state.

Since the impedance calculator 122 and the actual moisture content estimator 124 composing the moisture content detecting unit 128 are provided in the ECU 26, the ECU 26 is capable of appropriately controlling the FC 44 on the basis of the estimated actual moisture content.

In the above embodiments, as illustrated in FIG. 6, the loss in the load 32 is reduced as the FC power generation voltage Vfc is stepped up to increase the load end voltage Vinv to be applied to the load 32. Accordingly, if the direct connection state of the FCVCU 22 is required to produce the motor request power Pmotreq when the field-weakening control is performed to increase the number of revolutions Nm of the motor 14 in the FC vehicle 10, the load in the load 32 is reduced by setting the FCVCU 22 to the direct connection state, thereby effectively improve the mileage performance of the FC vehicle 10.

The FCVCU 22 steps up the FC power generation voltage Vfc, that is, controls the FC power generation voltage Vfc to adjust the difference in voltage between the primary side 1Sf and the secondary side 2S in the above embodiments. Instead of the above configuration, the FCVCU 22 may control the FC power generation current Ifc to adjust the difference in voltage between the primary side 1Sf and the secondary side 2S (to step up the FC power generation voltage Vfc). In other words, the FCVCU 22 may be a device that controls the FC power generation voltage Vfc to step up the FC power generation voltage Vfc and applies the stepped-up FC power generation voltage Vfc to the load 32 or may be a device that controls the FC power generation current Ifc to step up the FC power generation voltage Vfc and applies the stepped-up FC power generation voltage Vfc to the load 32.

While the embodiments of the present disclosure have been described above, it will be recognized and understood that various modifications can be made in the present disclosure on the basis of the content of the specification.

The present application describes a fuel cell system including a fuel cell; a load; a voltage adjustment unit that adjusts output voltage from the fuel cell and applies the output voltage to the load; a control unit that controls the voltage adjustment unit; and a moisture content detecting unit that detects actual moisture content in the fuel cell and a fuel cell vehicle to which the fuel cell system is applied.

The control unit controls the voltage adjustment unit by supplying an instruction signal resulting from superimposition of an alternating current signal on a target value of the output voltage to the voltage adjustment unit. The moisture content detecting unit detects an alternating current signal component included in the output voltage to detect the actual moisture content on the basis of the detected alternating current signal component.

In the present disclosure, the control unit increases the actual moisture content before setting the voltage adjustment unit to a direct connection state. In other words, in the present disclosure, the voltage adjustment unit is set to the direct connection state after the actual moisture content is increased in advance immediately before the voltage adjustment unit is set to the direct connection state to make the actual moisture content higher than the actual moisture content during the normal operation.

With the above configuration, even if the switching operation (the step up-down operation) in the voltage adjustment unit is stopped to disable the detection of the actual moisture content, it is possible to suppress a reduction in current-voltage (IV) characteristics of the fuel cell caused by the reduction in the actual moisture content in the direct connection state. Since the actual moisture content is increased immediately before the voltage adjustment unit is set to the direct connection state, it is possible to suppress an increase in frequency of the catalyst sintering to ensure the durability of the fuel cell.

Accordingly, in the present disclosure, it is possible to easily provide two advantages: the reduction in the loss in the voltage adjustment unit due to the direct connection state and the reduction in the loss in the load due to the increase in the moisture content. Consequently, it is possible to improve the efficiency of the entire fuel cell system, which includes the power generation efficiency of the fuel cell.

As a result, if the load in the fuel cell system includes a driving motor of the fuel cell vehicle when the fuel cell system is applied to the fuel cell vehicle, it is possible to easily improve the mileage performance of the fuel cell vehicle in conjunction with the improvement in the efficiency of the entire fuel cell system.

The fuel cell system preferably further includes a gas supply unit that is controlled by the control unit and that supplies reaction gas to the fuel cell. In this case, the control unit may increase the actual moisture content and the output voltage by increasing supply power or an amount of supply of the reaction gas to be supplied to the fuel cell, increasing an amount of power generation of the fuel cell, increasing an amount of humidification in the reaction gas, or decreasing a temperature of refrigerant for cooling down the fuel cell.

In any case, the increase in the actual moisture content allows the output voltage to be easily increased. In addition, since setting the voltage adjustment unit to the direct connection state after increasing the output voltage causes the high output voltage to be applied to the load. Accordingly, it is possible to reduce the loss in the load to improve the efficiency of the load.

The control unit may set the voltage adjustment unit to the direct connection state after the adjustment operation of the output voltage by the voltage adjustment unit is continued until the actual moisture content is increased to a certain target moisture content. In this case, the voltage adjustment unit is kept in the step-up state for a certain time before the actual moisture content reaches the target moisture content and priority is given to the detection of the actual moisture content. Setting the voltage adjustment unit to the direct connection state when the actual moisture content reaches the target moisture content allows the reduction in the IV characteristic of the fuel cell to be effectively suppressed. The target moisture content preferably has a value that suppresses the reduction in the IV characteristic in the direct connection state.

The gas supply unit preferably includes a fuel gas supplier that supplies and discharges fuel gas to and from an anode of the fuel cell and an oxidant gas supplier that supplies and discharges oxidant gas to and from a cathode of the fuel cell. In this case, the control unit is capable of easily increasing the actual moisture content and the output voltage before the voltage adjustment unit is set to the direct connection state by increasing supply pressure or an amount of supply of the oxidant gas to be supplied to the cathode through control of the oxidant gas supplier.

The oxidant gas supplier preferably includes a supply pipe through which supply oxidant gas is supplied to the cathode; a discharge pipe through which discharge oxidant gas from the cathode is discharged to the outside; a pump that is mounted to the supply pipe and that pumps the supply oxidant gas to the cathode; a humidifier that is provided between the cathode and the pump and that humidifies the supply oxidant gas; and a recirculation mechanism that is provided between the cathode and the humidifier and that supplies part of the discharge oxidant gas to a downstream side of the humidifier on the supply pipe.

The control unit preferably increases supply pressure or an amount of supply of the supply oxidant gas through control of the pump and preferably adjusts an amount of supply of the discharge oxidant gas to be supplied to the supply pipe through control of the recirculation mechanism. With this configuration, it is possible to efficiently increase the actual moisture content to the target moisture content before the voltage adjustment unit is set to the direct connection state.

The moisture content detecting unit preferably includes a voltage detector that detects the output voltage from the fuel cell; a current detector that detects output current from the fuel cell; an impedance calculator that calculates an impedance in the fuel cell using the output voltage and the output current; and an actual moisture content estimator that estimates the actual moisture content corresponding to the impedance. In this case, the impedance calculator and the actual moisture content estimator may be provided in the control unit. With this configuration, the control unit is capable of appropriately controlling the fuel cell on the basis of the estimated actual moisture content.

In the present disclosure, the voltage adjustment unit may adjust the difference in voltage between the fuel cell side of the voltage adjustment unit and the load by controlling the output voltage from the fuel cell or controlling the output current from the fuel cell. In other words, the voltage adjustment unit may be a device that controls the output voltage to adjust the output voltage and applies the output voltage to the load or may be a device that controls the output current to adjust the output voltage and applies the output voltage to the load.

Obviously, numerous modifications and variations of the present invention are possible in light of the above teachings. It is therefore to be understood that within the scope of the appended claims, the invention may be practiced otherwise than as specifically described herein.

What is claimed is:

1. A fuel cell system comprising:
a fuel cell;
a load;
a voltage adjustment unit that adjusts output voltage from the fuel cell and applies the output voltage to the load;
a control unit that controls the voltage adjustment unit; and
a moisture content detecting unit that detects actual moisture content in the fuel cell,
wherein the control unit controls the voltage adjustment unit by supplying an instruction signal resulting from superimposition of an alternating current signal on a target value of the output voltage to the voltage adjustment unit,
wherein the moisture content detecting unit detects an alternating current signal component included in the output voltage to detect the actual moisture content on the basis of the detected alternating current signal component, and
wherein the control unit increases the actual moisture content before setting the voltage adjustment unit to a direct connection state.

2. The fuel cell system according to claim 1, further comprising:
a gas supply unit that is controlled by the control unit and that supplies reaction gas to the fuel cell,
wherein the control unit increases the actual moisture content and the output voltage by increasing supply power or an amount of supply of the reaction gas to be supplied to the fuel cell, increasing an amount of power generation of the fuel cell, increasing an amount of humidification in the reaction gas, or decreasing a temperature of refrigerant for cooling down the fuel cell.

3. The fuel cell system according to claim 2,
wherein the control unit sets the voltage adjustment unit to the direct connection state after the adjustment operation of the output voltage by the voltage adjustment unit is continued until the actual moisture content is increased to a certain target moisture content.

4. The fuel cell system according to claim 3,
wherein the gas supply unit includes
a fuel gas supplier that supplies and discharges fuel gas to and from an anode of the fuel cell; and
an oxidant gas supplier that supplies and discharges oxidant gas to and from a cathode of the fuel cell, and
wherein the control unit increases the actual moisture content and the output voltage by increasing supply pressure or an amount of supply of the oxidant gas to be supplied to the cathode through control of the oxidant gas supplier.

5. The fuel cell system according to claim 4,
wherein the oxidant gas supplier includes
a supply pipe through which supply oxidant gas is supplied to the cathode;
a discharge pipe through which discharge oxidant gas from the cathode is discharged to the outside;
a pump that is mounted to the supply pipe and that pumps the supply oxidant gas to the cathode;
a humidifier that is provided between the cathode and the pump and that humidifies the supply oxidant gas; and
a recirculation mechanism that is provided between the cathode and the humidifier and that supplies part of the discharge oxidant gas to a downstream side of the humidifier on the supply pipe, and
wherein the control unit increases supply pressure or an amount of supply of the supply oxidant gas through control of the pump and adjusts an amount of supply of the discharge oxidant gas to be supplied to the supply pipe through control of the recirculation mechanism.

6. The fuel cell system according to claim 1,
wherein the moisture content detecting unit includes
a voltage detector that detects the output voltage from the fuel cell;
a current detector that detects output current from the fuel cell;
an impedance calculator that calculates an impedance in the fuel cell using the output voltage and the output current; and
an actual moisture content estimator that estimates the actual moisture content corresponding to the impedance, and
wherein the impedance calculator and the actual moisture content estimator are provided in the control unit.

7. A fuel cell vehicle comprising:
a driving motor,
wherein the driving motor of the fuel cell vehicle is included in the load in the fuel cell system according to claim 1.

8. A fuel cell system comprising:
a fuel cell;
a voltage adjustment device configured to adjust output voltage from the fuel cell and configured to apply the output voltage to a load;
a controller configured to supply an instruction signal including an alternating current signal and a target value of the output voltage to the voltage adjustment device to control the voltage adjustment device; and
a moisture content detector configured to detect an alternating current signal component included in the output voltage to detect actual moisture content in the fuel cell based on the alternating current signal component, the controller being configured to increase the actual moisture content before setting the voltage adjustment device to a direct connection state.

9. The fuel cell system according to claim 8, further comprising:
a gas supply device to be controlled by the controller and to supply reaction gas to the fuel cell,
wherein in order to increase the actual moisture content and the output voltage, the controller increases supply pressure or an amount of supply of the reaction gas to be supplied to the fuel cell, increases an amount of power generation of the fuel cell, increases an amount of humidification in the reaction gas, or decreases a temperature of refrigerant for cooling down the fuel cell.

10. The fuel cell system according to claim 9,
wherein the controller sets the voltage adjustment device to the direct connection state after controlling the voltage adjustment device to continue to adjust the output voltage until the actual moisture content is increased to a certain target moisture content.

11. The fuel cell system according to claim 10,
wherein the gas supply device comprises:
a fuel gas supplier configured to supply and discharge fuel gas to and from an anode of the fuel cell; and
an oxidant gas supplier configured to supply and discharge oxidant gas to and from a cathode of the fuel cell, and
wherein in order to increase the actual moisture content and the output voltage, the controller controls the oxidant gas supplier to increase supply pressure or an amount of supply of the oxidant gas to be supplied to the cathode.

12. The fuel cell system according to claim 11,
wherein the oxidant gas supplier comprises:
a supply pipe through which supply oxidant gas is to be supplied to the cathode;
a discharge pipe through which discharge oxidant gas from the cathode is to be discharged to an outside;
a pump to pump the supply oxidant gas to the cathode, the pump being mounted to the supply pipe;
a humidifier to humidify the supply oxidant gas, the humidifier being provided between the cathode and the pump; and
a recirculation mechanism to supply part of the discharge oxidant gas to a downstream side of the humidifier on the supply pipe, the recirculation mechanism being provided between the cathode and the humidifier, and
wherein the controller controls the pump to increase supply pressure or an amount of supply of the supply oxidant gas and controls the recirculation mechanism to adjust an amount of supply of the discharge oxidant gas to be supplied to the supply pipe.

13. The fuel cell system according to claim 8,
wherein the moisture content detector comprises:
a voltage detector configured to detect the output voltage from the fuel cell;
a current detector configured to detect output current from the fuel cell;
an impedance calculator configured to calculate an impedance in the fuel cell using the output voltage and the output current; and
an actual moisture content estimator configured to estimate the actual moisture content corresponding to the impedance, and
wherein the impedance calculator and the actual moisture content estimator are provided in the controller.

14. The fuel cell system according to claim 8, further comprising the load.

15. A fuel cell vehicle comprising:
a driving motor,
wherein the driving motor of the fuel cell vehicle is included in the load in the fuel cell system according to claim 14.

16. A fuel cell system comprising:
a fuel cell;
voltage adjustment means for adjusting output voltage from the fuel cell and for applying the output voltage to a load;
control means for supplying an instruction signal including an alternating current signal and a target value of the output voltage to the voltage adjustment means to control the voltage adjustment means; and
moisture content detecting means for detecting an alternating current signal component included in the output voltage to detect actual moisture content in the fuel cell based on the alternating current signal component, the control means being configured to increase the actual moisture content before setting the voltage adjustment means to a direct connection state.
